(19) United States
(12) Patent Application Publication
(10) Pub. No.: US 2026/0198511 A1
(43) Pub. Date: Jul. 16, 2026

(54) NOVEL FAT TISSUE MIMETIC

(71) Applicant: CONOPCO, INC., D/B/A UNILEVER, Hoboken, NJ (US)

(72) Inventors: Leonardus, Marcus FLENDRIG, Wageningen (NL); HyunJung KIM, Wageningen (NL); Maria Elena PEDRINI, Wageningen (NL); Marco SANTAGIULIANA, Wageningen (NL)

(73) Assignee: CONOPCO, INC., D/B/A UNILEVER, Hoboken, NJ (US)

(21) Appl. No.: 19/134,797

(22) PCT Filed: Dec. 20, 2023
(86) PCT No.: PCT/EP2023/086930

§ 371 Date: Jun. 2, 2025

(30) Foreign Application Priority Data
Dec. 23, 2022 (EP) 22216413.9
Dec. 23, 2022 (EP) 22216414.7
Mar. 29, 2023 (EP) 23165166.2
May 9, 2023 (EP) 23172346.1
May 9, 2023 (EP) 23172347.9
May 9, 2023 (EP) 23172348.7

(51) Int. Cl. A23D 7/005; A23D 7/04; A23J 3/22; A23L 29/10; A23L 29/244; A23L 29/256; A23L 29/262

(52) U.S. Cl. CPC A23D 7/0053; A23D 7/04; A23J 3/227; A23L 29/10; A23L 29/244; A23L 29/256; A23L 29/262

(57) ABSTRACT

A novel fat tissue mimetic. A process for the preparation of the fat tissue mimetic. The use of the fat tissue mimetic as a component of a meat analogue, meat product, or a product comprising both meat analogue and meat components. The product comprising the fat tissue mimetic.

### FIELD OF THE INVENTION

Novel fat tissue mimetic, use of the novel fat tissue mimetic for meat analogue products and meat products, process for the preparation of the novel fat tissue mimetic. Food product comprising the novel fat tissue mimetic.

### BACKGROUND OF THE INVENTION

Fat tissue mimetics, when present as a component of a food product, require sensory characteristics that mimic animal fat tissue, including a visual change from an opaque to more translucent composition in addition to sufficient oil release during cooking, firmness, robustness, and mouthfeel. Furthermore, the fat tissue mimetic must be suitable for industrial manufacturing, i.e.: material viscosity must be suitable for processing.

CN109730272 A1 discloses a fat mimetic for use in animal products. The mimetic material consists of konjac glucomannan, carrageenan, corn germ oil, beta-glucan and an alkaline component: either sodium carbonate or calcium hydroxide. Treatment of konjac with an alkaline component results in deacetylated konjac. Deacetylated konjac forms hydrogen bonds between some of the molecules and consequently crystallizes. Deacetylated konjac is a different chemical entity than konjac and has a different physical structure with different physical properties.

WO2021229027 A1 discloses a composition for use as a substitute for animal fat, e.g.: pork products such as bacon. The composition comprises water, oil, an alginate salt and glucomannan. The fat substitute must not comprise methyl cellulose and must comprise a pH regulator such as glucono-delta lactone. The fat substitute is reported to have characteristics close to those of animal fat, in particular, when compared to similar formulations with alternative hydrocolloids disclosed in the application. Similarly, the fat substitute is reported to be comparatively malleable and flexible, and cooks with a comparatively satisfactory oil release.

The present invention is directed towards the provision of a fat tissue mimetic that not only achieves the desired sensory profile, such as a visual change from an opaque to more translucent composition in addition to sufficient oil release during cooking, firmness, robustness, and mouthfeel such as chewiness. Furthermore, the compositions of the invention achieve the physical characteristics that are necessary for its use as a component of a meat analogue or meat product, i.e.: adhesion to other meat analogue components to for, e.g.: bacon cuts, and processability.

Furthermore, it has been observed that when a food product comprising a fat tissue mimetic composition is present as more than one unit, for example, pieces or slices (similar to bacon rashers or slices of pepperoni, salami or mortadella), the units that are in contact with each other are easily separable. Improved separability of food product units, such as pieces or slices (also known as improved ‘peelability’), is advantageous because the consumer has more control over removal of individual units from packaging. Furthermore, improved separability is advantageous because the consumer has more control during the cooking process to enable uniform cooking of each piece or slice.

### SUMMARY OF THE INVENTION

A fat tissue mimetic comprising:
a. From 45 wt % to 75 wt % water,
b. From 10 wt % to 40 wt % fat,
c. From 0 wt % to 5 wt % carbohydrate,
d. From 1 wt % to 8 wt % emulsifier composition,
e. From 3 wt % to 10 wt % hydrocolloid composition,
f. From 0 wt % to 5 wt % additive composition.

In an embodiment of the invention, a fat tissue mimetic comprising:
a. From 45 wt % to 75 wt % water,
b. From 10 wt % to 40 wt % fat,
c. From 0.5 wt % to 5 wt % protein,
d. From 0 wt % to 5 wt % carbohydrate,
e. From 1 wt % to 8 wt % emulsifier composition,
f. From 3 wt % to 10 wt % hydrocolloid composition,
g. From 0 wt % to 5 wt % additive composition.

A process for the preparation of the fat tissue mimetic. The use of the fat tissue mimetic as a component of a meat analogue, meat product, or a product comprising both meat analogue and meat components. The product comprising the fat tissue mimetic.

### DETAILED DESCRIPTION OF THE INVENTION

A fat tissue mimetic comprising:
a. From 45 wt % to 75 wt % water,
b. From 10 wt % to 40 wt % fat,
c. From 0 wt % to 5 wt % carbohydrate,
d. From 1 wt % to 8 wt % emulsifier composition,
e. From 3 wt % to 10 wt % hydrocolloid composition,
f. From 0 wt % to 5 wt % additive composition.

In an embodiment of the invention, a fat tissue mimetic comprising:
a. From 45 wt % to 75 wt % water,
b. From 10 wt % to 40 wt % fat,
c. From 0.5 wt % to 5 wt % protein,
d. From 0 wt % to 5 wt % carbohydrate,
e. From 1 wt % to 8 wt % emulsifier composition,
f. From 3 wt % to 10 wt % hydrocolloid composition,
g. From 0 wt % to 5 wt % additive composition,
   with the proviso that the emulsifier composition does not comprise protein.

In an embodiment of the invention, a fat tissue mimetic comprising:
a. From 45 wt % to 75 wt % water,
b. From 10 wt % to 40 wt % fat,
c. From 0 wt % to 5 wt % carbohydrate,
d. From 1 wt % to 8 wt % emulsifier composition comprising protein,
e. From 3 wt % to 10 wt % hydrocolloid composition,
f. From 0 wt % to 5 wt % additive composition,
   wherein the hydrocolloid composition comprises konjac, carrageenan and methyl cellulose,
   wherein the weight ratio of konjac to carrageenan is greater than 1:1 and the weight ratio of carrageenan to methyl cellulose is greater than 1:1.

In a preferred embodiment of the invention, a fat tissue mimetic comprising:
a. From 45 wt % to 75 wt % water,
b. From 10 wt % to 40 wt % fat,
c. From 0 wt % to 5 wt % carbohydrate,
d. From 1 wt % to 8 wt % emulsifier composition comprising protein,
e. From 3 wt % to 10 wt % hydrocolloid composition,
f. From 0 wt % to 5 wt % additive composition.
   wherein the hydrocolloid composition comprises konjac, carrageenan and methyl cellulose,
   wherein the weight ratio of konjac to carrageenan is greater than 1:1 and the weight ratio of carrageenan to methyl cellulose is greater than 1:1, and the protein is from 0.025 wt % to 5.0 wt % of the fat tissue composition.

In a preferred embodiment, the invention is related to a fat tissue mimetic comprising:
a. From 50 wt % to 65 wt % water,
b. From 20 wt % to 40 wt % fat,
c. From 0.5 wt % to 5 wt % carbohydrate,
d. From 1 wt % to 8 wt % emulsifier composition comprising protein,
e. From 3 wt % to 10 wt % hydrocolloid composition,
f. From 0 wt % to 5 wt % additive composition.
   wherein the hydrocolloid composition comprises konjac, carrageenan and methyl cellulose,
   wherein the weight ratio of konjac to carrageenan is greater than 1:1 and the weight ratio of carrageenan to methyl cellulose is greater than 1:1, and the protein is from 0.025 wt % to 5.0 wt % of the fat tissue composition.

Fat tissue mimetic means an edible composition that has the physical characteristics of animal fat tissue. Typically, fat tissue mimetics are comprised of ingredients originating from non-animal sources such as plants. The term ‘fat tissue mimetic’ is intended to be interchangeable with the term ‘fat tissue mimetic composition’.

In an embodiment of the invention the fat tissue mimetic comprises from 3 wt % to 10 wt % hydrocolloid composition, from 3 wt % to 9 wt % hydrocolloid composition, from 4 wt % to 8.5 wt % hydrocolloid composition, from 5 wt % to 7.5 wt % hydrocolloid composition.

The hydrocolloid composition comprises one or more hydrocolloids. Hydrocolloids may be extracted from plants or animals, be a product of a fermentation process, or be a chemically modified form of the extract or fermentation process. Preferably the hydrocolloids originate from non-animal sources. Examples of hydrocolloids include non-animal polysaccharides.

Non-animal polysaccharides are, for example, carob bean gum, tara gum, guar gum, locust bean gum, curdlan, cassia gum, gum arabic, konjac, carrageenan, methylcellulose, xanthan gum, pectin, alginate and alginic acid.

In an embodiment of the invention the hydrocolloid composition comprises carrageenan, konjac and methyl cellulose. In an embodiment of the invention the hydrocolloid composition comprises one or more hydrocolloids selected from the group consisting of carrageenan, konjac, methyl cellulose and mixtures thereof.

In a further embodiment of the invention the hydrocolloid composition comprises carrageenan, konjac, methyl cellulose and alginate. In an embodiment of the invention the hydrocolloid composition comprises one or more hydrocolloids selected from the group consisting of carrageenan, konjac, methyl cellulose, alginate and mixtures thereof.

In a further embodiment of the invention the hydrocolloid composition comprises carrageenan, konjac, methyl cellulose, alginate and alginic acid. In an embodiment of the invention the hydrocolloid composition comprises one or more hydrocolloids selected from the group consisting of carrageenan, konjac, methyl cellulose, alginate, alginic acid and mixtures thereof. In an embodiment of the invention the fat tissue mimetic comprises konjac and carrageenan and the weight ratio of konjac to carrageenan is greater than 1:1.

In a further embodiment of the invention, the hydrocolloid composition comprises one or more hydrocolloids selected from the group consisting of carrageenan, konjac, methyl cellulose, alginate, alginic acid.

Carrageenan means sulphated polysaccharides that are extracted from red seaweeds such as the Chrondrus, Gigartina, and Euchema species. Carrageenan is the name for a family of salts of sulfated galactans with a sulfate group content of 18-40% and are categorized into three different classes based on their sulfate content: Kappa-carrageenan; iota-carrageenan; and lambda-carrageenan. In a preferred embodiment the carrageenan is kappa-carrageenan.

Konjac means a water-soluble hydrocolloid obtained from the flour of the A. konjac plant. CAS registry number 37220-17-0 and EINECS No 253-404-6 correspond to konjac mannan, a term that covers for both konjac gum and konjac glucomannan. Konjac gum (E 425 i) and konjac glucomannan (E 425 ii) are distinguished in the definition regarding the main components (≥75% carbohydrate vs ≥95% total dietary fibre on a dry weight basis) and in molecular weight. Preferably the konjac is konjac gum.

Methyl cellulose means methylated cellulose and is identified by the CAS number 9004-67-5.

The methyl cellulose employed in accordance with the present invention preferably has a methoxyl content of 20% to 40%, more preferably of 24% to 36%. In another preferred embodiment, the methyl cellulose employed has a viscosity at a temperature of 20′C and a concentration of 2 wt. % in water of from 20,000 to 1,000,000 cP, 15 more preferably of from 30,000 to 500,000 cP and most preferably of from 35,000 to 200,000 cP. The molecular weight of the methyl cellulose preferably lies in the range of 100 to 250 kDa, more preferably in the range of 150 to 220 kDa. According to a preferred embodiment, the methyl cellulose has a gelation temperature of at least 30° C., more preferably a gelation temperature in the range of 35° C. to 60° C., most preferably a gelation temperature in the range of 40° C. to 50° C.

Exemplary methyl cellulose ingredients include: Methocel Bind 250 DowDupont (433026) and Methocel™ MX), Dupont/Solae Overseas; and Metolose® 100TS, Shin Etsu of America, Inc.

Alginate means the salt form of alginic acid. In an embodiment of the invention alignate may comprise one or more of sodium alginate, potassium alignate, ammonium alginate, magnesium alginate, and calcium alginate. In an embodiment of the invention alignate is selected from the group consisting of sodium alginate, potassium alignate, ammonium alginate, magnesium alginate, calcium alginate and mixtures thereof. In a preferred embodiment of the invention alignate is selected from the group consisting of sodium alginate, potassium alignate, calcium alginate and mixtures thereof. In a preferred embodiment of the invention alignate comprises sodium alginate and calcium alginate. In a preferred embodiment of the invention alignate comprises potassium alignate and calcium alginate. In a preferred embodiment alginate comprises calcium alginate. In a preferred embodiment alginate is calcium alginate. The alignate may be provided as a commercial alginate ingredient comprising an alginate or blend of alginates. Such commercial alginate ingredients include Vegedan MA 1951 (Danisco, www.danisco.com) or Binder HB-002836 (BDF Ingredients, bdfingredients.com). If the alginate is not provided as an alginate ingredient, the calcium alginate salt may be prepared in situ by the presence of a water-soluble alginate salt such as sodium and/or potassium alginate, calcium carbonate, and typically, a pH regulator such as glucono-delta-lactone or a ferment. Exemplary ingredients and processes are described in WO2021229027 A1.

In an embodiment of the invention konjac is present in an amount of from 1.5 wt % to 4.0 wt %, from 1.75 wt % to 3.75 wt %, preferably from 2.0 wt % to 3.5 wt %.

In an embodiment of the invention carrageenan is present in an amount of from 1.0 wt % to 3.0 wt %, from 1.25 wt % to 3.0 wt %, preferably from 1.5 wt % to 2.5 wt %.

In an embodiment of the invention methyl cellulose is present in an amount of from 0.5 wt % to 3.0 wt %, from 0.75 wt % to 2.5 wt %, preferably from 1.0 wt % to 2.0 wt %.

In an embodiment of the invention the fat tissue mimetic comprises from 1.5 wt % to 4.0 wt % konjac; from 1.0 wt % to 3.0 wt % carrageenan; and from 0.5 wt % to 3.0 wt % methyl cellulose.

In a preferred embodiment of the invention the fat tissue mimetic comprises from 1.75 wt % to 3.75 wt % konjac; from 1.25 wt % to 3.0 wt % carrageenan; and from 0.75 wt % to 2.5 wt % methyl cellulose.

In a more preferred embodiment of the invention the fat tissue mimetic comprises from 2.0 wt % to 3.5 wt % konjac; from 1.5 wt % to 2.5 wt % carrageenan; and from 1.0 wt % to 2.0 wt % methyl cellulose.

In an embodiment of the invention the hydrocolloid composition comprises from 40 wt % to 50 wt % konjac; from 30 wt % to 33 wt % carrageenan; and from 17 wt % to 30 wt % methyl cellulose.

In a preferred embodiment of the invention the hydrocolloid composition comprises from 41 wt % to 47 wt % konjac; from 32 wt % to 33 wt % carrageenan; and from 20 wt % to 27 wt % methyl cellulose.

In a more preferred embodiment of the invention the hydrocolloid composition comprises from 44 wt % konjac; from 31 wt % to 33 wt % carrageenan; and from 22 wt % to 25 wt % methyl cellulose.

In an embodiment of the invention the fat tissue mimetic comprises from 0.25 wt % to 3.0 wt % alginate, from 0.5 wt % to 2.5 wt % alginate, preferably from 0.75 wt % to 2.0 wt % alginate.

Preferably the alginate comprises calcium alginate, preferably the alginate salt is calcium alginate. In an embodiment of the invention alginate salt is provided as an alginate ingredient such as Vegedan MA 1951 or Binder HB-002836.

In an embodiment of the invention the fat tissue mimetic comprises from 0.5 wt % to 3.0 wt % alginate ingredient, from 0.75 wt % to 2.5 wt % alginate ingredient, preferably from 1.0 wt % to 2.0 wt % alginate ingredient.

In an embodiment of the invention the fat tissue mimetic comprises from 0.5 wt % to 3.0 wt % Vegedan MA 1951 or Binder HB-002836, from 0.75 wt % to 2.5 wt % Vegedan MA 1951 or Binder HB-002836, preferably from 1.0 wt % to 2.0 wt % Vegedan MA 1951 or Binder HB-002836.

In an embodiment of the invention the amount (weight percentage) of konjac present in the hydrocolloid composition is greater than the amount of carrageenan present in the hydrocolloid composition. In an embodiment of the invention the amount (weight percentage) of carrageenan present in the hydrocolloid composition is greater than the amount of methyl cellulose in the hydrocolloid composition. In an embodiment of the invention the weight ratio of konjac to carrageenan present in the hydrocolloid composition is greater than 1:1 and the weight ratio of carrageenan to methyl cellulose present in the hydrocolloid composition is greater than 1:1.

The weight ratio of konjac to carrageenan present in the hydrocolloid composition is from 0.5:1 to 3:1; from 0.8:1 to 2.2:1, preferably from 1:1 to 2:1, preferably from 1.1:1 to 1.5:1.

The weight ratio of konjac to methyl cellulose present in the hydrocolloid composition is from 0.5:1 to 3:1; from 0.8:1 to 2.2:1, preferably from 1:1 to 2:1, preferably from 1.1:1 to 1.5:1.

The weight ratio of carrageenan to methyl cellulose present in the hydrocolloid composition is from 0.5:1 to 3:1; from 0.8:1 to 2.2:1, preferably from 1:1 to 2:1, preferably from 1.1:1 to 1.5:1.

In an embodiment of the invention the weight ratio of konjac to carrageenan present in the hydrocolloid composition is from 0.5:1 to 3:1; the weight ratio of konjac to methyl cellulose present in the hydrocolloid composition is from 0.5:1 to 3:1; and the weight ratio of carrageenan to methyl cellulose present in the hydrocolloid composition is from 0.5:1 to 3:1.

In a preferred embodiment of the invention the weight ratio of konjac to carrageenan present in the hydrocolloid composition is preferably from 1:1 to 2:1; the weight ratio of konjac to methyl cellulose present in the hydrocolloid composition is preferably from 1:1 to 2:1; and the weight ratio of carrageenan to methyl cellulose present in the hydrocolloid composition is preferably from 1:1 to 2:1.

In a more preferred embodiment of the invention the weight ratio of konjac to carrageenan present in the hydrocolloid composition is preferably from 1.1:1 to 1.5:1; the weight ratio of konjac to methyl cellulose present in the hydrocolloid composition is preferably from 1.1:1 to 1.5:1; and the weight ratio of carrageenan to methyl cellulose present in the hydrocolloid composition is preferably from 1.1:1 to 1.5:1.

In an embodiment of the invention the hydrocolloid composition comprises kappa-carrageenan, konjac and methyl cellulose. In an embodiment of the invention the hydrocolloid composition comprises one or more hydrocolloids selected from the group consisting of kappa-carrageenan, konjac and methyl cellulose. In an embodiment of the invention the hydrocolloid composition consists of kappa-carrageenan, konjac and methyl cellulose.

An emulsifier is typically an amphiphilic compound that stabilizes a suspension of two liquids that do not mix naturally, for example, oil and water. Emulsifiers include lecithin, such as egg yolk lecithin or soy lecithin, sunflower lecithin, wheat germ, modified corn starches, and non-animal protein isolates and non-animal protein concentrates. Modified corn starches include waxy corn starch such as OSA starch (octenyl succinic anhydride, INS 1450, E1450) commercially available as N-Creamer 2230 supplied by Ingredion.

In an embodiment of the invention the fat tissue mimetic comprises from 1 wt % to 8 wt % emulsifier composition, preferably from 1.5 wt % to 4 wt % emulsifier composition, preferably from 2 wt % to 3.5 wt % emulsifier composition, more preferably from 2.2 wt % to 2.8 wt % emulsifier composition.

In an embodiment of the invention the emulsifier composition comprises waxy corn starch and lecithin. In an embodiment of the invention the emulsifier composition comprises emulsifiers selected from the group consisting of waxy corn starch, lecithin and mixtures thereof. In an embodiment of the invention the emulsifier composition consists of waxy corn starch and lecithin.

In an embodiment of the invention the emulsifier composition comprises waxy corn starch, lecithin and protein. In an embodiment of the invention the emulsifier composition comprises emulsifiers selected from the group consisting of waxy corn starch, lecithin, protein and mixtures thereof. In an embodiment of the invention the emulsifier composition consists of waxy corn starch, lecithin and protein.

In an embodiment of the invention the emulsifier composition comprises protein.

In an embodiment of the invention the fat tissue mimetic comprises from 0.01 wt % to 0.2 wt % lecithin. Preferably, the fat tissue comprises from 0.05 wt % to 0.15 wt % lecithin. More preferably, the fat tissue comprises from 0.08 wt % to 0.12 wt % lecithin.

In an embodiment of the invention the fat tissue mimetic comprises from 0.5 wt % to 2.5 wt % waxy corn starch. Preferably, the fat tissue mimetic comprises from 1.0 wt % to 2.0 wt % waxy corn starch. More preferably, the fat tissue mimetic comprises from 1.2 wt % to 1.8 wt % waxy corn starch.

Non-animal protein isolates and concentrates are derived from protein sources and may be, for example, legume protein isolates such as soy protein isolate, soy protein concentrate, chickpea protein isolate, wheat protein isolate, pea protein isolate and mung bean protein isolate. Other plant proteins are, for example, potato protein, 20 RuBisCo, moong 8S globulin, pea globulin, pea albumin, lentil protein, zein, faba bean, sunflower protein, rapeseed protein, hemp protein, carob protein and oleosin.

Proteins are obtainable from a variety of protein sources such as animals (including dairy) and plants. Preferably the proteins are plant proteins. The plant proteins may be soy protein, cereal protein, rapeseed protein, cottonseed protein, sunflower protein, sesame protein, lupin protein, potato protein and algae protein. Preferred plant proteins are soy protein, wheat protein, oat protein, bran protein and combinations thereof. More preferred plant proteins are soy protein, wheat protein and combinations thereof. Most preferably, the protein is soy protein.

For example, soy protein may be obtainable from soy beans but also products derived from soy beans such as soy protein concentrate, or soy protein isolate. The difference between these sources is typically the protein content. Soy protein isolate typically comprises from 70 wt % to 100 wt % soy protein. Soy protein concentrate typically comprises from 50 wt % to 70 wt % soy protein.

In an embodiment of the invention the fat tissue mimetic comprises from 0.01 wt % to 10.0 wt % protein, from 0.02 wt % to 7.5 wt % protein, from 0.025 wt % to 5.0 wt % protein. Preferably, the fat tissue mimetic comprises from 0.5 wt % to 4.0 wt % protein. Preferably, the fat tissue mimetic comprises from 0.1 wt % to 2.0 wt % protein. More preferably, the fat tissue mimetic comprises from 0.5 wt % to 1.5 wt % protein.

In an embodiment of the invention the fat tissue mimetic comprises from 0.025 wt % to 5.0 wt % protein isolate, from 0.05 wt % to 5.0 wt % soy protein isolate. Preferably, the fat tissue mimetic comprises from 0.1 wt % to 4.0 wt % soy protein isolate. Preferably, the fat tissue mimetic comprises from 0.3 wt % to 2.0 wt % soy protein isolate. More preferably, the fat tissue mimetic comprises from 0.5 wt % to 1.5 wt % soy protein isolate.

Carbohydrate means a polysaccharide, preferably the carbohydrate comprises amylose and amylopectin. In an embodiment of the invention the fat tissue mimetic comprises 0 wt % to 5 wt % carbohydrate, 0.25 wt % to 4.0 wt % carbohydrate, from 0.5 wt % to 3.5 wt % carbohydrate. Preferably, the fat tissue mimetic comprises from 1.0 wt % to 3.0 wt % carbohydrate. Preferably, the fat tissue mimetic comprises from 1.5 wt % to 2.5 wt % carbohydrate.

In an embodiment of the invention the carbohydrate is starch selected from the group consisting of wheat starch, potato starch, corn starch, rice starch, tapioca starch, cassava starch or mixtures thereof. The starch may be modified starch, for example: native potato starch, modified high amylose corn starch, tapioca hydroxypropyl di-starch phosphate.

In an embodiment of the invention the fat tissue mimetic comprises from 0 wt % to 5.0 wt % starch, from 0 wt % to 4.0 wt % starch, from 0.25 wt % to 4.0 wt % starch, from 0.5 wt % to 3.5 wt % starch. Preferably, the fat tissue mimetic comprises from 1.0 wt % to 3.0 wt % starch. Preferably, the fat tissue mimetic comprises from 1.5 wt % to 2.5 wt % starch.

Fat means a composition comprising saturated and unsaturated triglycerides. The term ‘fat’ typically comprises both fats and oils. Fats and oils may be obtained from natural sources such as plant, seed and dairy products, or fractions thereof, or prepared synthetically. Exemplary fats and oils include: linseed oil, castor oil, sunflower oil, soybean oil, safflower oil, corn oil, rapeseed oil, canola oil, olive oil, tung oil, cotton seed oil, peanut oil, palm kernel oil, coconut oil, cocoa butter, palm oil, palm oil fractions and mixtures thereof.

The term “oil” encompasses compositions comprising triglycerides that are liquid at ambient temperature. The term ‘fat’ may also be known to mean compositions comprising triglycerides that are solid at ambient temperature. However, according to this invention ‘fat’ is intended to mean a composition comprising triglycerides.

The melting point of a fat can be determined according to ISO 6321 (2021). In an embodiment of the invention the melting point of the fat is from −30° C. to 35° C., preferably from −27.5° C. to 15° C., more preferably from −25° C. to 0° C.

In an embodiment of the invention the fat tissue mimetic comprises from 10 wt % to 40 wt % fat, 20 wt % to 40 wt % fat, from 22 wt % to 38 wt % fat, from 25 wt % to 35 wt % fat.

In an embodiment of the invention the fat is a liquid oil.

In an embodiment of the invention the fat is selected from the group consisting of linseed oil, castor oil, sunflower oil, soybean oil, rapeseed oil, safflower oil, olive oil, maize oil, tung oil, cotton seed oil, peanut oil, palm kernel oil, coconut oil, cocoa butter, palm oil, palm oil fractions and mixtures thereof.

In an embodiment of the invention the fat is selected from the group consisting of sunflower oil, soybean oil, rapeseed oil, and mixtures thereof.

In an embodiment of the invention the fat is rapeseed oil. Rapeseed oil may also be known as canola oil.

In an embodiment of the invention the fat tissue mimetic composition comprises an additive composition. The additive composition may comprise additive ingredients such as one or more flavourings, preservatives and salts. In an embodiment of the invention the fat tissue mimetic comprises an additive composition comprising one or more flavourings, preservatives, and salts.

In an embodiment of the invention the additive composition comprises flavourings. In an embodiment of the invention the additive composition comprises preservatives. In an embodiment of the invention the additive composition comprises salts. In an embodiment of the invention the additive composition comprises salt.

In an embodiment of the invention the additive composition comprises flavourings, preservatives and salts. In an embodiment of the invention the additive composition comprises additives selected from the group consisting of flavourings, preservatives, salts and mixtures thereof.

In an embodiment of the invention the fat tissue mimetic comprises from 0 wt % to 5 wt % additive composition, from 0.5 wt % to 4 wt % additive composition, from 1 wt % to 3 wt % additive composition.

It has been found that the fat tissue mimetic has good taste and therefore flavours are not necessarily required. Nevertheless, dependant on the application of the fat tissue (i.e. the meat analogue that will comprise the fat tissue mimetic), the fat tissue mimetic may also comprise flavour components.

The fat tissue mimetic comprises from 0 wt % to 5 wt % of a flavour or flavours, preferably from 1 wt % to 4 wt %, more preferably from 2 wt % to 3 wt %.

The fat tissue mimetic may also comprise salt or salts. The fat tissue mimetic preferably comprises from 0 wt % to 5 wt % salt, more preferably from 1 to 4 wt %, more preferably still from 1.5 wt % to 3 wt %.

It has been found that the fat tissue is remarkably stable, therefore only low levels of a preservative system are required. Moreover, any preservative system can be very simple. The additive composition may comprise a preservative system, preferably the preservative system comprises citric-acid and lactic acid, preferably the preservative system comprises citric acid, preferably the preservative system comprises lactic acid. The additive composition comprises preservatives selected from the group consisting of citric acid, lactic acid and mixtures thereof.

The fat tissue mimetic preferably comprises from 0 wt % to 5 wt % preservatives, more preferably from 1 wt % to 4 wt %, more preferably still from 1.5 wt % to 3 wt %. The term preservative system is intended to be synonymous with the term preservatives.

The fat tissue mimetic preferably comprises from 0 wt % to 5 wt % preservatives, more preferably from 1 wt % to 4 wt %, more preferably still from 1.5 wt % to 3 wt %.

In an embodiment of the invention the fat tissue mimetic comprises from 45 wt % to 75 wt % water, from 48 wt % to 70 wt % water, from 50 wt % to 65 wt % water.

In a second aspect of the invention the fat tissue mimetic composition is a component of a food product, for example a meat analogue product, a meat product, or a product comprising both meat analogue and meat components. In an embodiment of the invention, the invention is directed towards a food product comprising a fat tissue mimetic composition and a meat analogue product, a meat product, or a product comprising both meat analogue and meat components.

Meat analogue products typically comprise a meat analogue dough. Exemplary meat analogue doughs are disclosed in Sustainable Meat Production and Processing, Elsevier, 2019, Pages 103-126; Chapter 6: Plant-Based Meat Analogues, and comprise water (from 50 wt % to 80 wt %), textured vegetable proteins (from 10 wt % to 25 wt %), non-textured proteins (from 4 wt % to 20 wt %), flavorings (from 3 wt % to 10 wt %), fat (from 0 wt % to 15 wt %), binding agents (from 1 wt % to 5 wt %), and coloring agents (from 0 wt % to 0.5 wt %).

In a preferred embodiment, the food product is a meat analogue food product comprising a meat analogue dough and a fat tissue mimetic. Preferably the food product is bacon, pepperoni, salami or mortadella.

It has been observed that when a food product comprising one or more a fat tissue mimetic compositions is present as more than one unit, for example, pieces or slices (similar to bacon rashers or slices of pepperoni, salami or mortadella), the units that are in contact with each other are easily separable. Improved separability of food product units, such as pieces or slices (also known as improved ‘peelability’), is advantageous because the consumer has more control over removal of individual units from packaging. Furthermore, improved separability is advantageous because the consumer has more control during the cooking process to enable uniform cooking of each piece or slice.

For example, food product units present in packaging in a layered or stacked format are observed to have improved separability, enabling ease of separation from packaging prior to cooking.

In a preferred embodiment the fat tissue mimetic composition comprises:
g. From 50 wt % to 65 wt % water,
h. From 20 wt % to 40 wt % fat,
i. From 0.5 wt % to 5 wt % carbohydrate,
j. From 1 wt % to 8 wt % emulsifier composition,
k. From 3 wt % to 9 wt % hydrocolloid composition,
l. From 0 wt % to 5 wt % additive composition.

In a preferred embodiment the emulsifier composition comprises protein.

In a preferred embodiment emulsifier composition comprises modified starch.

In a preferred embodiment the emulsifier composition comprises lecithin.

In a preferred embodiment the hydrocolloid composition comprises konjac, carrageenan and methyl cellulose.

In a preferred embodiment the protein is soy protein.

In a preferred embodiment the modified starch is waxy corn starch.

In a preferred embodiment the carbohydrate is starch.

In a preferred embodiment the carbohydrate is selected from the group consisting of potato starch, corn starch, tapioca starch and mixtures thereof.

In a preferred embodiment the fat is a liquid oil.

In a preferred embodiment the fat tissue mimetic composition comprises from 1.5 wt % to 4 wt % konjac, from 1.0 wt % to 3.5 wt % carrageenan and from 0.5 wt % to 3 wt % methyl cellulose.

In a preferred embodiment, the fat tissue mimetic comprises:
a. From 45 wt % to 75 wt % water,
b. From 10 wt % to 40 wt % fat having a melting point of from −30° C. to 35° C.;
c. From 0 wt % to 5 wt % starch;
d. from 0.01 wt % to 0.2 wt % lecithin;
e. from 0.5 wt % to 2.5 wt % waxy corn starch;
f. from 0.025 wt % to 5.0 wt % soy protein;
g. from 1.5 wt % to 4.0 wt % konjac;
h. from 1.0 wt % to 3.0 wt % carrageenan;
i. from 0.5 wt % to 3.0 wt % waxy corn starch;
j. From 0 wt % to 5 wt % additive composition.

In a preferred embodiment the starch is selected from the group consisting of native potato starch, modified high amylose corn starch and tapioca hydroxypropyl di-starch phosphate

In a particularly preferred embodiment, the invention is related to a fat tissue mimetic comprising:
a. From 50 wt % to 65 wt % water,
b. From 20 wt % to 40 wt % fat having a melting point of from −30° C. to 35° C.;
c. From 0.5 wt % to 5 wt % starch,
d. from 0.01 wt % to 0.2 wt % lecithin;
e. from 0.5 wt % to 2.5 wt % waxy corn starch;
f. from 0.025 wt % to 5.0 wt % soy protein;
g. from 1.5 wt % to 4.0 wt % konjac;
h. from 1.0 wt % to 3.0 wt % carrageenan;
i. from 0.5 wt % to 3.0 wt % waxy corn starch;
j. From 0 wt % to 5 wt % additive composition.

In a particularly preferred embodiment the starch is selected from the group consisting of native potato starch, modified high amylose corn starch and tapioca hydroxypropyl di-starch phosphate.

In a third aspect, the invention relates to a process for the preparation of a fat tissue mimetic composition. The process comprises the steps of:
a. Mixing lecithin and water,
b. Adding the remaining emulsifier composition to the product of step a. and mixing,
c. Adding fat to the product of step b. and mixing under vacuum,
d. Adding water and hydrocolloid composition and carbohydrates,
e. Adding an additive composition to the product of step d. and mixing under vacuum.

Alternatively, the process comprises the steps of:
a. Mixing the emulsifier composition and water,
b. Adding fat to the product of step a. and mixing under vacuum,
c. Adding water (crushed ice), hydrocolloid composition, carbohydrate and additive composition to the product of step b. and mixing under vacuum.

In a preferred embodiment the emulsifier composition of step a. comprises protein, lecithin and modified starch.

Where the fat mimetic comprises protein, the process may comprise the steps of:
a. Mixing protein and water,
b. Adding water and hydrocolloid composition, emulsifier composition and carbohydrate to the product of step a. and mixing under vacuum,
c. Adding fat to the product of step b. and mixing under vacuum,
d. Adding an additive composition to the product of step c. and mixing under vacuum.

The water of steps a. and b. is typically cold and may be used in a frozen form such as crushed ice or ice chips. The water temperature may be from 0° C. to 16° C.

The vacuum of step b. is from 0.01 to 0.95 bar, from 0.05 bar to 0.9 bar, from 0.2 bar to 0.8 bar.

The words ‘comprising’ and ‘containing’ used herein should not be interpreted restrictively as meaning ‘consisting of’. In other words, besides the features listed after these words, non-listed features may be present.

Unless specified otherwise, numerical ranges expressed in the format ‘from x to y’ or ‘x-y’ are understood to include x and y. When for a specific feature multiple preferred ranges are described in the format ‘from x to y’ or ‘x-y’, it is understood that all ranges combining the different endpoints are also contemplated. For the purpose of the invention ambient temperature is defined as a temperature of about 20° C.

Unless indicated otherwise, weight percentages (wt %) are based on the total weight of the composition. Also, unless indicated otherwise, weight percentages as based on wet weight.

### Examples

### Method 1: Preparation of Fat Tissue Mimetics:

Soy protein was mixed with chilled water. The hydrated soy protein was added to a vacuum bowl chopper together with crushed ice, the hydrocolloid composition, emulsifier composition and carbohydrates were added and mixed at a vacuum of 0.2 bar for 3 minutes on speed 2. The vacuum was released, the fat(s) were added and mixed at 0.2 bar for 2 minutes on speed 2. The vacuum was released, the additive composition was added and mixed at 0.2 bar for 2 minutes on speed 2.

### Method 2: Method of Measurinq Translucency, Chewiness and Robustness:

Frozen cooked fat tissue mimetics produced according to Method 1 were brought to room temperature about 1 hour before testing. Samples were sliced to a thickness of 2.5 mm by using a food slicer machine (DEKO, Arnhem, The Netherlands).

For sensory observation of frying behaviour, a non-stick pan was heated to 160° C. first and slices of samples were added to the pan and baked for 90 sec at 140° C.~170° C. on one side then turned over and cooked on the other side for another 90 sec with observation. The sensory attributes were scored on a scale of 1 to 5 (1 stands for ‘unacceptable’ and 5 stands for ‘excellent’) The average and total average scores are listed in Table 1.

### Chewiness:

Chewiness means the amount of work required to masticate the sample into a state ready for swallowing.

### Robustness:

The raw samples (oven-cooked) were scored for robustness (structural integrity of a fat mimic slice when wiggling the sample with 2 fingers).

### Translucency:

During and after the frying process, translucency was visually observed.

### Method of Measuring Translucency of the Fat Tissue Mimics

Samples were cut to a thickness of 2.6 mm, were fried at 180° C. for 5 minutes in small gourmet pans. After frying the samples were cooled down at ambient temperature for 2 minutes. Digital images of these samples before frying and after frying were taken against a white background sheet with black stripes to calculate translucency. These digital images were made under controlled lighting using a DigiEye imaging system (imaging colorimeter) with Nikon D7000 digital camera and Nikon 35 mm F/2 D lens. From the Digi-Eye images, the L*a*b* values were measured against a black and white background by software and dE, dE gives an indication on the degree of color change. The translucency, expressed by the calculated dE, is given for raw (non-fried) and fried samples, the change is translucency was calculated by subtracting the value for the pan-fried samples from their corresponding raw sample starting material.

$$\begin{matrix}Formula dE & dE = sqrt \{ {( L 1 - L 2 )}^{2} + {( a 1 - a 2 )}^{2} + {( b 1 - b 2 )}^{2} \} \\ L * a * b * ( 1 ) & colour value against black background \\ L * a * b * ( 2 ) & colour value against white background\end{matrix}$$

### Method of Measuring Oil Release/Water Release:

The pan with samples were weighed before and after cooking the sample in order to calculate water release. The excess of liquid oil inside the pan and on both sides of the sample were carefully removed by using a tissue. The samples were then weighed once more to calculate oil release.

### Examples

TABLE 1
Physical Properties of Fat Mimetic Formulations.

| Ingredient | Ex 1 | Ex 2 | Ex 3 | Ex 4 | Ex 5 |
|---|---|---|---|---|---|
| Water | 47.1 | 47.1 | 47.1 | 45.6 | 47.6 |
| Soy protein isolate | 4.0 | 1.0 | 1.0 | 1.0 | 1.0 |
| Ice | 10 | 10 | 10 | 10 | 10 |
| Waxy corn starch | 0 | 1.5 | 1.5 | 1.5 | 1.5 |
| Lecithin | 0 | 0 | 0.1 | 0.1 | 0.1 |
| Alginate | 0 | 0 | 0 | 1.5 | 1.5 |
| Ingredient | | | | | |
| Rapeseed oil | 30 | 30 | 30 | 30 | 30 |
| Hydrocolloid | 5.6 | 5.6 | 5.6 | 5.6 | 5.6 |
| Composition* | | | | | |
| Starch | 2.0 | 2.0 | 2.0 | 2.0 | 0 |
| Flavours | 2.7 | 2.7 | 2.7 | 2.7 | 2.7 |
| Total | 100.0 | 100.0 | 100.0 | 100.0 | 100.0 |
| Fat Release (%) | 5.5 | 6.7 | 9.8 | 10.1 | 8.1 |
| Change in | 7.4 | 9.1 | 7.0 | 11.7 | 14.7 |
| translucency | | | | | |
| between raw | | | | | |
| product and pan- | | | | | |
| fried product [dE] | | | | | |
| Robustness after | 2.82 | 3.5 | 3.1 | 3.55 | (Not measured) |
| oven cooking | | | | | |
| Chewiness after | 3 | 3 | 3 | 3 | (Not measured) |
| pan frying | | | | | |

| Ingredient | Trade name | Supplier |
|---|---|---|
| Rapeseed oil | Rapeseed oil | Van der Steen |
| Soy Protein Isolate | Supro EX 37 HG | Dupont/Solae Overseas |
| Waxy corn starch | N-Creamer-2230 | Ingredion |
| Lecithin | Sunflower Lecithin | Danisco/Dupont |
| | Fluid | |
| Methylcellulose | Methocel Bind 250 | Dupont/Solae Overseas |
| | DowDupont | |
| | (433026) | |
| Konjac gum | WELCO Konjac | Barentz, WELDING GMBH |
| | Gum 1001 | & CO. KG |
| Carrageenan | Carrageenan Welco | Barentz, WELDING GMBH |
| | GelForm 1263 | & CO. KG |
| Starch | Native Potato Starch | Ingredion |
| | N-Hance 59 | |
| Alginate Ingredient | Vegedan | Danisco |
| | Binder HB | BDF Ingredients |

*Hydrocolloid composition consists of konjac, kappa-carrageenan and methyl cellulose; wherein the weight percentage of konjac is greater than kappa-carrageenan, and the weight percentage of kappa-carrageenan is greater than methyl cellulose.

All formulations demonstrate a change in translucency after frying. All formulations when present as a fat mimetic change from an opaque white appearance to a translucent appearance, mimicking the change in appearance of meat fat.

Furthermore, all formulations demonstrate oil release during frying (from 5.5% to 10.1%). The oil release demonstrated enables the consumer to cook the fat tissue mimetic without the need for additional oil.

Furthermore, all examples demonstrated increased ease of separability of the food product units from each other.

| | Peelability | Force | Stickiness | Breakability |
|---|---|---|---|---|
| Ex 3 | ++ | − | / | // |

Example 3 was compared with a sample of The Vegetarian Butcher ‘Specktakel’.

++=easier

+=a little easier

Same=same

/=a little less

//=Less

The Vegetarian Butcher ‘Specktakel’ did not comprise lecithin or waxy corn starch.

### Method:

Two slices of bacon prepared according to Ex 3 were placed in contact with each other with approximately 50% overlap, the same formation was created with two slices of The Vegetarian Butcher ‘Specktakel’.

A panel of experienced sensory testers separated the two slices of bacon and provided a score of ease of peelability, force, stickiness and breakability. The scores ranged from: easier, a little easier, the same, a little less and less. The average score from the panelists was calculated.

Peelability is the ease of peeling the top slice from the bottom slice.

Force is the force required to peel the top slice from the bottom slice.

Stickiness is the degree of the top slice sticking to the bottom slice.

Breakability the degree to which the sample breaks into pieces while peeling the top slice from the bottom slice.

When compared to the The Vegetarian Butcher ‘Specktakel’:

Ex 3 is easier to peel when two slices are separated.

Ex 3 requires less force to peel the top slice from the bottom slice.

Ex 3 is less prone to stick to other slices when two slices are separated.

Ex 3 is less prone to break into pieces when two slices are separated.

1. A fat tissue mimetic composition comprising:
a. From 45 wt % to 75 wt % water,
b. From 10 wt % to 40 wt % fat,
c. From 0 wt % to 5 wt % carbohydrate,
d. From 1 wt % to 8 wt % emulsifier composition
e. From 3 wt % to 10 wt % hydrocolloid composition,
f. From 0 wt % to 5 wt % additive composition;
wherein the hydrocolloid composition comprises konjac, carrageenan and methyl cellulose,
wherein the weight ratio of konjac to carrageenan is greater than 1:1 and the weight ratio of carrageenan to methyl cellulose is greater than 1:1,
and the emulsifier composition comprises protein.

2. The fat tissue mimetic composition according to claim 1, wherein the emulsifier composition comprises modified starch.

3. The fat tissue mimetic composition according to claim 1, wherein the emulsifier composition comprises lecithin.

4. The fat tissue mimetic composition according to claim 1, wherein the protein is soy protein.

5. The fat tissue mimetic composition according to claim 1, wherein the modified starch is waxy corn starch.

6. The fat tissue mimetic composition according to claim 1, wherein the carbohydrate is starch.

7. The fat tissue mimetic composition according to claim 1, wherein the carbohydrate is selected from the group consisting of potato starch, corn starch, tapioca starch and mixtures thereof.

8. The fat tissue mimetic composition according to claim 1, wherein the fat is a liquid oil.

9. The fat tissue mimetic composition according to claim 1, comprising from 1.5 wt % to 4 wt % konjac, from 1.0 wt % to 3.5 wt % carrageenan and from 0.5 wt % to 3 wt % methyl cellulose.

10. The fat tissue mimetic composition according to claim 1, wherein the protein is present in an amount of from 0.025 wt % to 5.0 wt % of the fat tissue mimetic composition.

11. The fat tissue mimetic composition according to claim 1, wherein the hydrocolloid composition comprises alginate.

12. A process for the preparation of a fat tissue mimetic composition according to claim 1, comprising the steps of:
a. Mixing the emulsifier composition and water,
b. Adding fat to the product of step a. and mixing under vacuum,
c. Adding water, hydrocolloid composition, carbohydrate and additive composition to the product of step b. and mixing under vacuum.

13. (canceled)

14. An edible product comprising a fat tissue mimetic composition according to claim 1.

15. The edible product according to claim 14 comprising a meat analogue dough.
